(19) United States
(12) Patent Application Publication
(10) Pub. No.: US 2012/0246228 A1
(43) Pub. Date: Sep. 27, 2012

(54) SHARING CHANNELS

(75) Inventors: Ojiakonobi Udezue, Sammamish, WA (US); Benjamin John Smith, Seattle, WA (US)

(73) Assignee: Microsoft Corporation, Redmond, WA (US)

(21) Appl. No.: 13/052,673

(22) Filed: Mar. 21, 2011

(51) Int. Cl. G06F 15/16

(52) U.S. Cl. 709/204

(57) ABSTRACT

One or more techniques and/or systems are disclosed for sharing content. A user can acquire content, such as locally and/or remotely, that they wish to share with one or more recipients. The user provides or establishes one or more endpoints (e.g., email alias, cell-phone/text messaging address, etc.) for one or more recipients with which to share content using a sharing channel. A universal resource identifier (URI), comprising a link to the content to be shared is generated. Upon receiving an indication of sharing (e.g., drag-n-drop of content into the channel), at least one of the selected content and the URI are automatically sent to the one or more endpoints for the respective one or more recipients via the sharing channel. The user can thus share a plurality content with multiple recipients at multiple different endpoints in a single act.

### BACKGROUND

Digital content, such as digital memories (e.g., images, video, URLs, and/or other digital artifacts, etc.), documents, text, data, etc., can be acquired/accessed by a user, manipulated, and/or shared with other users. Often, digital media or content is collected by capturing images (e.g., photography), and/or by retrieving them from an online source (e.g., Internet). Users can also create and/or receive documents, write text, receive content from a third-party, etc. Commonly, users store digital content on their local devices (e.g., desktop, attached storage, handheld device, etc.), and/or remotely (e.g., storage network, cloud-based storage). Further, users often share digital content with others, such as by uploading to a website, loading to a social networking site, storing on a shared network, emailing, or sending to some receiving endpoint for one or more other users to access, for example.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Currently, sharing digital memories (e.g., photos, videos, URLs and/or other digital artifacts, etc.), for example, can comprise a multi-phase type of exchanging of content even when performed over highly performant equipment and channels. Typically, user need to find/acquire the content they wish to share, and then put it on a channel (e.g., a communication portal) and address it to an intended recipient, then send it the content (e.g., using email), which is done each time content is shared, and for each intended recipient. Further, the recipient receives the content and can organize it as desired. As an example, if the recipient wishes to review all content that has been shared between them and the sender, they need to find respective memory packets or blocks or packages of shared content, and/or acquire software that organizes the content. Additionally, If the recipient receives memories or content across a variety of channels available (e.g., email, instant message, text, social networks, etc), a task of viewing and organizing may be made even more difficult.

Accordingly, one or more techniques and/or systems are disclosed that can make the sharing of content more efficient and can provide an improved user experience. For example, instead of actively sending content to the same people, groups of people, and/or networks, the user can merely select content for sharing in a sharing channel. Further, the user may not need to select how to notify recipients of newly shared content each time they wish to share content. For example, a sharing channel may be initially setup for sharing content to desired recipients, using desired endpoints, and the sharing channel can be edited, as desired, to add/remove recipients, edit endpoints, etc. Further, the recipient may automatically be notified of newly shared content, for example, and the shared content can be organized in the sharing channel for later viewing by the recipient, such as by using a URI for the sharing channel.

In one embodiment for sharing content, a user can select at least one endpoint (e.g., location to receive content) for a recipient, and the at least one endpoint can be associated with respective one or more recipients in a sharing channel. Further, the user can select content to be shared with the sharing channel, and upon receiving the user selection of content to share using the sharing channel, the selected content and a universal resource identifier (URI) can be automatically sent to the one or more endpoints for the respective one or more recipients. Additionally, the URI sent with the shared content can comprise a link to a storage location of the selected content, such as for use by a recipient to access the sharing channel.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for sharing content.

FIG. 2 is a flow diagram illustrating one embodiment where one or more portions of one or more techniques described herein may be implemented.

FIG. 3 is a flow diagram illustrating one embodiment where one or more portions of one or more techniques described herein may be implemented.

FIGS. 4A and 4B illustrate example environments where one or more portions of one or more of the techniques described herein may be implemented.

FIG. 5 is a component diagram of an exemplary system for sharing user content.

FIG. 6 is a component diagram illustrating one embodiment where one or more systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for a first user to share content, such as media (e.g., images, video, audio, etc.), documents and/or programming, etc. with one or more second users utilizing a user friendly, intuitive, sharing channel. A variety of combinations of recipients and recipient information may be employed by the sharing channel to filter recipients and deliver shared content to the second users over a variety of avenues, for example. As an example, content can be dragged by the first user and dropped in/on the sharing channel to automatically share the content with recipients linked to the sharing channel, in a manner provided by a configuration of the sharing channel (e.g., email, text, webpage, etc.).

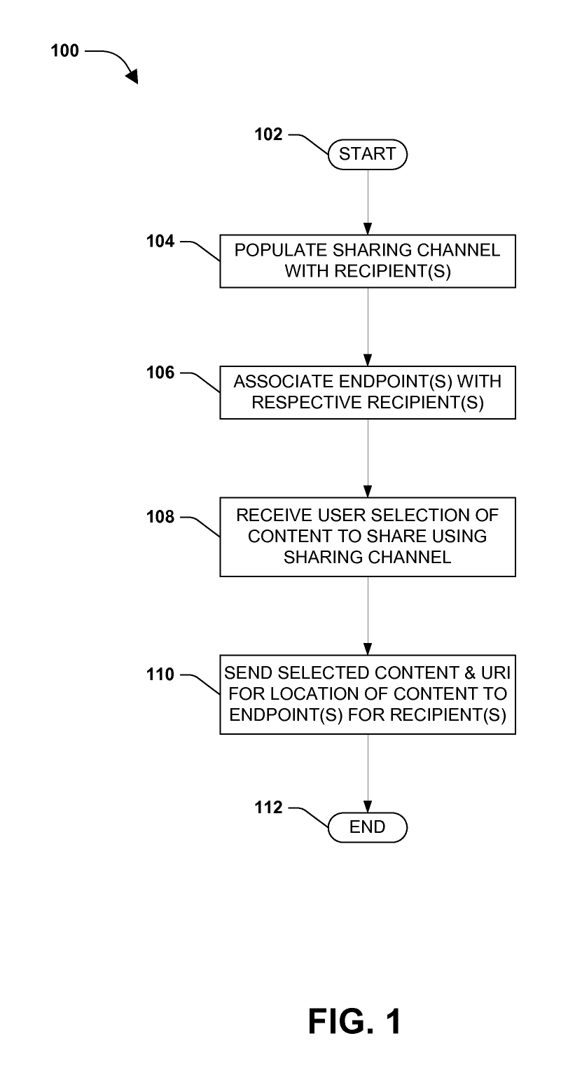

FIG. 1 is a flow diagram illustrating an exemplary method 100 for sharing content. The exemplary method 100 begins at 102 and involves populating a sharing channel with one or more recipients, at 104, for example, with which a user wishes to share content. For example, an online sharing service may comprise a remote storage service (e.g., cloud-based storage) that allows the user to remotely store content. In this example, a sharing channel can be associated with the remotely stored content and comprise one or more recipients of content shared by the user (e.g., friends, family, peers, etc.). Further, for example, a plurality of sharing channels may be associated with the content online, where respective sharing channels comprise a different list of recipients (e.g., for sharing of different content).

At 106, one or more endpoints are associated with the respective one or more recipients in the sharing channel. For example, an endpoint can comprise an address, marker, or location point that may received the content shared by the user. An endpoint may identify a location to which shared content may be sent by the sharing channel and received by the recipient associated with the endpoint, for example, an email address, mobile phone, number, server site uniform resource locator (URL), social network site location, even a URI for a group of people can comprise recipient endpoints. As an example, the user may enter an email address for the respective recipients in the sharing channel.

At 108, user selected content is received, such as by the user selecting the content to share with the recipient(s), using the sharing channel. For example, the user can select (e.g., click on with a mouse) a user interface (UI) icon that is indicative of the content to share and drag (e.g., move the mouse) the icon to a UI icon indicative of the sharing channel, where it may be dropped (e.g., unclicked using the mouse). As another example, the user may use a menu item to select the content, such as by right clicking the UI icon representation of the content, which can provide for moving the content to the sharing channel.

At 110, upon receiving the selection of the content to share, at least one of the selected content and a universal resource identifier (URI) is automatically sent to the one or more endpoints for the respective one or more recipients comprised in the sharing channel. The URI comprises a link to a storage location of the selected shared user content for the sharing channel. For example, once the user drags and drops the selected content to the sharing channel, the content selected for sharing can be sent to an email, mobile number, or some content receiving location associated with the respective endpoints in the sharing channel. Further, the URI sent to the recipient(s) can be used by a recipient to access the selected content in the sharing channel, such as to review previously shared content in the sharing channel. In this manner, content can be shared with multiple recipients in a single action. Accordingly, to send a digital image to multiple recipients who are merely accessible via different independent manners, a user does not have to compose an email and attach the image thereto to send it to a first recipient, compose a text message and attach the image thereto to send it to a second recipient, upload the image to a website and send instructions to a third recipient so that the third recipient can view the image from the website, etc. Rather, the user/sender can merely place the content into the sharing channel and the content will be distributed to the different recipients associated with the channel in the respective appropriate manners as defined in the channel for the different users.

Having shared the selected content and the URI with the one or more recipients in the sharing channel the exemplary method 100 ends at 112.

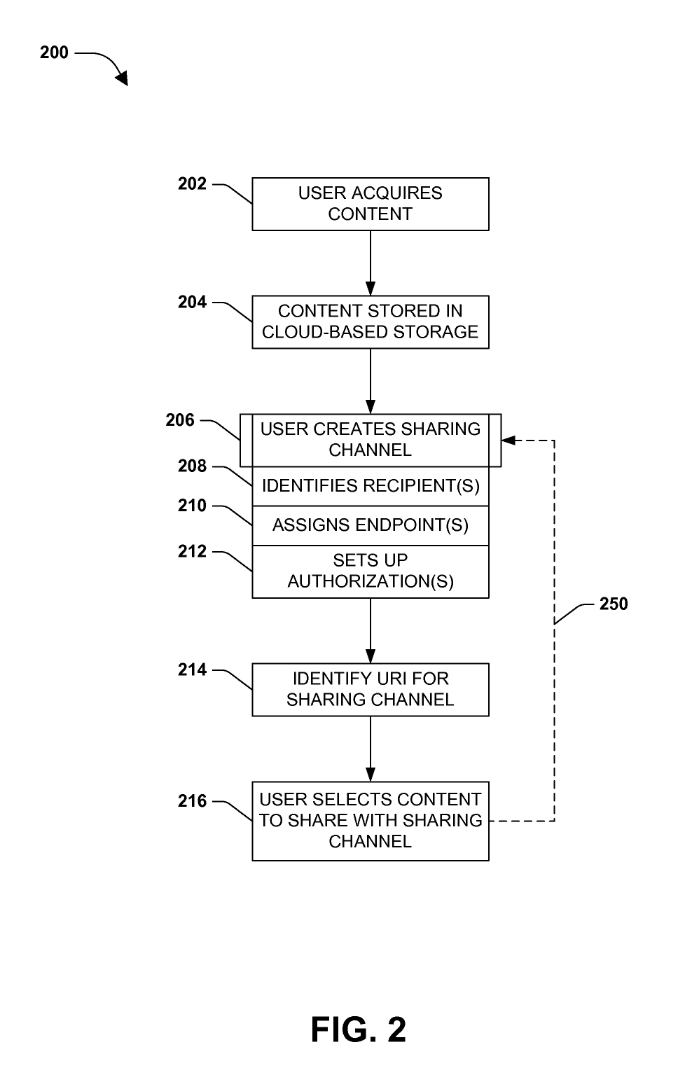

FIG. 2 is a flow diagram illustrating one embodiment 200 where one or more portions of one or more techniques described herein may be implemented. At 202, a user acquires content, such as media, documents, text, data, etc., in any of a number of manners (e.g., taking pictures, creating a document, writing text, receiving content from a third-party, etc.). Commonly, users acquire media or content comprising memories of activities, such as photos, video and/or audio, for example. Further, users may collect documents related to work, study and/or other activities. Additionally, users collect information related to particular interests, such as articles on a hobby, sport and/or other activity.

At 204, the content, which can be selected for sharing, can be stored in a cloud-based storage, such that the content is accessible over a network using a URI, such as a URL for the cloud-based storage location accessible over the Internet. As an example, there are a number of online content storage services that allow a user to upload content to the service's cloud-based servers for storage. In this example, the user may be able to access the content by navigating to the service's website URL, and logging into the storage service, such as using a username and password. These online services typically allow the user to view, interact with, upload, download, and/or send content to another user.

In one embodiment, (in addition to or alternative to cloud based storage) the content may be stored locally, such as on a local machine of the user (e.g., laptop, handheld computer, desktop, attached storage, networked storage, detachable storage, etc.). In one example, the local storage comprising the stored content may be accessible over a network using the URI (e.g., a storage server or networked storage location connected to the Internet). Further, storing the content locally can comprise storing the content on a local area network, for example, comprising network attached storage, or some other storage connected to a local network.

At 206 in the example embodiment 200, a sharing channel can be created, which may be used to share user selected content. Creating the sharing channel can comprise identifying one or more recipients for sharing the selected content, at 208. For example, a user may wish to create a sharing channel for immediate family (e.g., mother, father, brothers, sisters, etc.) with which to share family related content, and thus contact information for these recipients (e.g., respective email addresses) may be identified for association with the channel. As another example, the user may wish to create a sharing channel comprising friends, co-workers, social network connections, or any combination of recipients/entities for sharing desired content. As an example, recipients may be identified by a name (e.g., username, given name, etc.) or some other identification. Further, as an example, a recipient may comprise a social network, a group, or some network which the user desires to share selected content.

At 210, at least one endpoint can be assigned to the respective recipients in the sharing channel. An endpoint may comprise a location that the recipient may receive the selected content to be shared, such as an email address, instant message address, mobile number for texting, a URI identifying a network location, etc., where a recipient may be associated with more than one endpoint (e.g., so that a recipient may view a digital image from a sender via email and/or text messaging, for example).

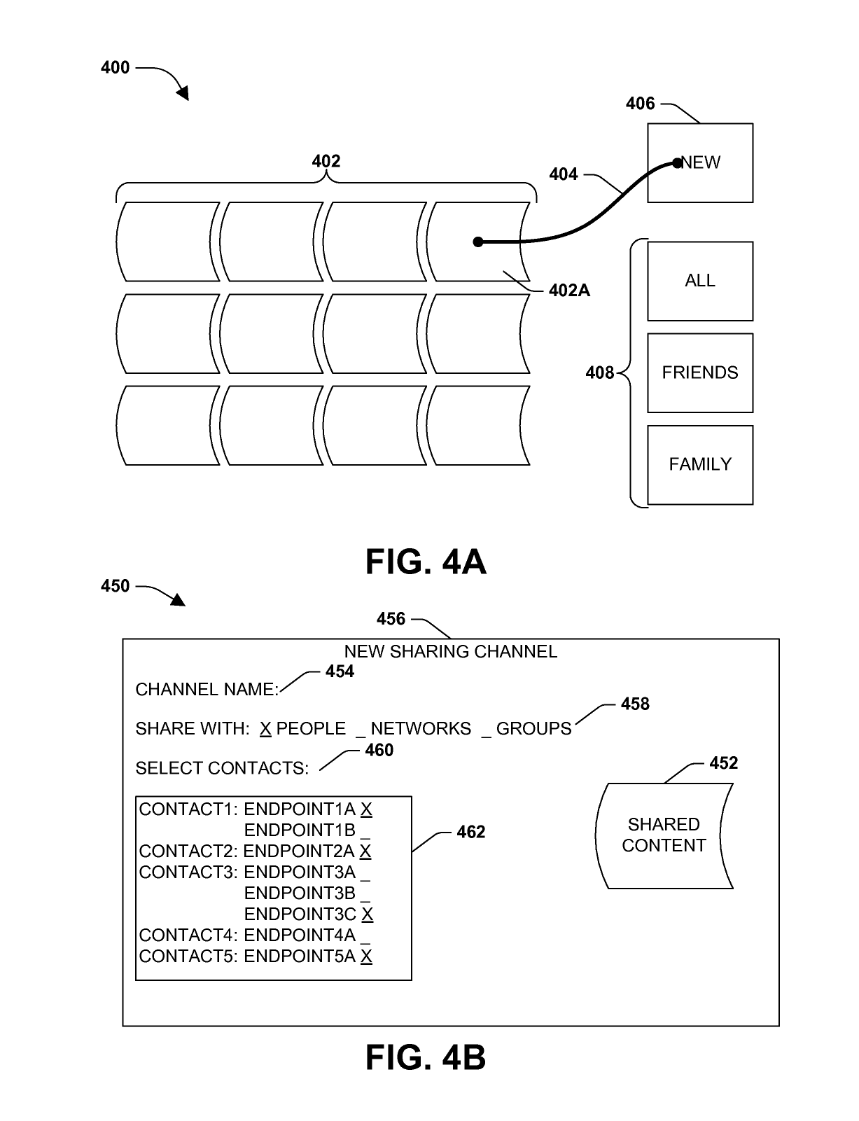

FIGS. 4A and 4B illustrate example environments 400 and 450 where one or more of the techniques described herein may be implemented. In the example embodiment 450 of FIG. 4B, a new sharing channel 456 can be created. Contacts 460 for the sharing channel 456 may be selected, along with one or more endpoints, such as from the user's contact list; and/or may be input by the user. In this example 450, the user may select a type of recipient 458 with which to share content 452, such as people, networks (e.g., social networks), and groups. The contacts can comprise selected recipients and their respective endpoints 462, such as using “endpoint3C” for Contact3, etc. Further, in this example, the user may add a channel name 454 to identify the sharing channel.

Returning to FIG. 2, at 212, creating the sharing channel can comprise identifying one or more authorizations for the selected content for the respective one or more recipients, for example, and setting up the authorization(s) for the respective recipients. As an example, the content selected by the user for the sharing channel may be accessed by a recipient, such as for viewing, editing, posting comments, downloading, etc. In this embodiment, when the sharing channel is set up initially (e.g., or after the channel is set up) the types of interactions (e.g., viewing, editing, downloading, etc.) that a recipient is authorized for can be set up by the user.

At 214, a URI for the sharing channel can be identified. For example, the URI can identify an address, or location for a recipient to access the sharing channel, such as to review previously shared content, and/or to interact with shared content (e.g., comment on media). In one embodiment, the URI may comprise a universal resource locator (URL) that may be used to access the storage location of the selected content in a cloud-based storage component. For example, a recipient may enter the URL in a browser to navigate to a site that allows the recipient to view and interact with at least some of the previously shared content.

At 216, the user can select content to share with the sharing channel. As described above, the user may select content from a local source, such as on a local storage, and/or may select content stored on a remote server, such as in a cloud-based storage service. In one embodiment, the sharing channel can be portable. For example, the sharing channel may be located on the user's desktop, and the user can select local content to share with the sharing channel (e.g., documents, a calendar, contacts, media, etc.). As another example, the sharing channel may be located in a browser connected with an online storage service (e.g., or social network), and the user can select content from the storage service to share with the sharing channel (e.g., documents, contacts, online media, etc.). That is, the sharing channel may be moved (e.g., by dragging and dropping a UI icon for the channel) from one location to another (e.g., so that the UI icon for the channel is located close to content (e.g., a UI icon for the content) to be placed into the sharing channel).

In one embodiment, the sharing channel can comprise “multi-instance” portability. For example, the sharing channel may be defined locally, and/or in a cloud-based service, and one or more instances of the sharing channel can be used across a plurality of other platforms (e.g., websites, remote servers, etc.). As an illustrative example, a user may access a first instance of the sharing channel locally, such as by logging-in to their client device using a cloud-enabled operating system (OS) (e.g., using a desktop application, and/or the OS online, etc.), and utilize the sharing channel locally (e.g., to share locally available content). Further, in this example, the user may navigate to a website where a second instance of the sharing channel can be accessed, such as by logging-in to the site (e.g., such as a social network, content aggregations site, and/or a cloud-based storage site, etc.). Additionally, the user may utilize the second instance of the sharing channel with whatever content may be available at the website, for example.

In one embodiment, at 250, the user may select content to create a new sharing channel, at 206. For example, prior (or subsequent) to creating a sharing channel, and populating the sharing channel with one or more recipients comprising one or more endpoints, the user may select content they wish to share, and use the selected content to create a new sharing channel.

As an illustrative example, in the example embodiment 400 of FIG. 4A, the user may select content 402A (e.g., a digital image) from a plurality of stored content 402 (e.g., multiple digital images), such as stored on a remote (or local) storage service. The selected content can be dragged 404 to a UI element 406 that initiates creation of a new sharing channel. Alternately, the user may merely select the UI element 406, such as by double clicking on the icon, to initiate the creation of a new sharing channel. In this example, the user has the option of selecting the content 402A for sharing to create the new channel 406, and/or sharing via one or more existing sharing channels 408.

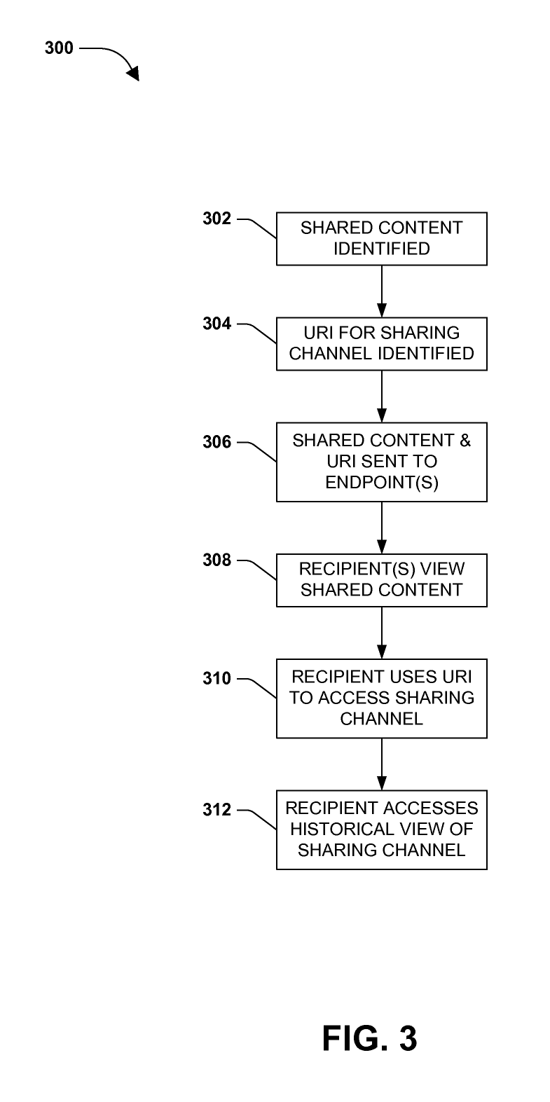

FIG. 3 is a flow diagram illustrating one embodiment 300 where one or more portions of one or more techniques may be implemented. At 302, content selected by a user for sharing is identified. For example, as illustrated in FIG. 4A, the user may click on the content 402A and drag it 404 to an existing sharing channel 408 or a new channel. In FIG. 4B, the selected content comprises shared content 452 identified for sharing using the sharing channel.

At 304, a URI for the sharing channel is identified. For example, the URI can comprise a URL that allows a recipient to access at least some of the content selected for the sharing channel. At 306, at least one of the shared content and the URI are sent to at least one of the endpoints for the respective one or more recipients in the sharing channel. In one embodiment, once the content and URI are identified for the sharing channel, they are automatically sent to the endpoint(s). In another embodiment, the user may be prompted to activate the sending to the recipients (e.g., by selecting a UI element button or menu item).

At 308, the recipient(s) receive the shared content and URI, and can view the shared content. For example, if a recipient endpoint is an email address, the recipient may view the shared content in their email client/application. As another example, if the endpoint is a mobile number, the recipient may view (and/or otherwise interact with) the shared content on their smartphone. Further, at 310, the recipient is provided access to the selected content for the sharing channel by activating the URI. For example, the recipient may select the URI, such as by activating a URL link, and the recipient's browser may navigate to the website that provides access to the selected shared content.

At 312, the recipient can be provided access to an historical view of at least some previously selected content for the sharing channel. For example, the recipient may utilize the URI to locate the sharing channel, such as provided by a remote server, or by the user's local machine, and the sharing channel can display previously shared content. As an example, the shared content in the sharing channel may be viewed by date of sharing, and the recipient can browse through previously shared content. Further, depending on the recipient's authorizations set up by the user/sender for the sharing channel, the recipient may interact with the previously shared content, such as to comment, edit, download, etc.

A system may be devised that provides for a user to share content with one or more recipient using a sharing channel. The sharing channel can be preconfigured with a variety of recipient information so that the shared content can be delivered to the recipients in a desired manner. By pre-configuring the sharing channel to deliver content to recipients in a desired manner, selected content can be added to the sharing channel by the user, and automatically delivered to the recipients in the sharing channel, thus allowing the user to share one or pieces of content with one or more recipient entities in a single action, even where different recipient entities may receive content in different manners (e.g., email, text messaging, through a browser, social network, microblog, etc.).

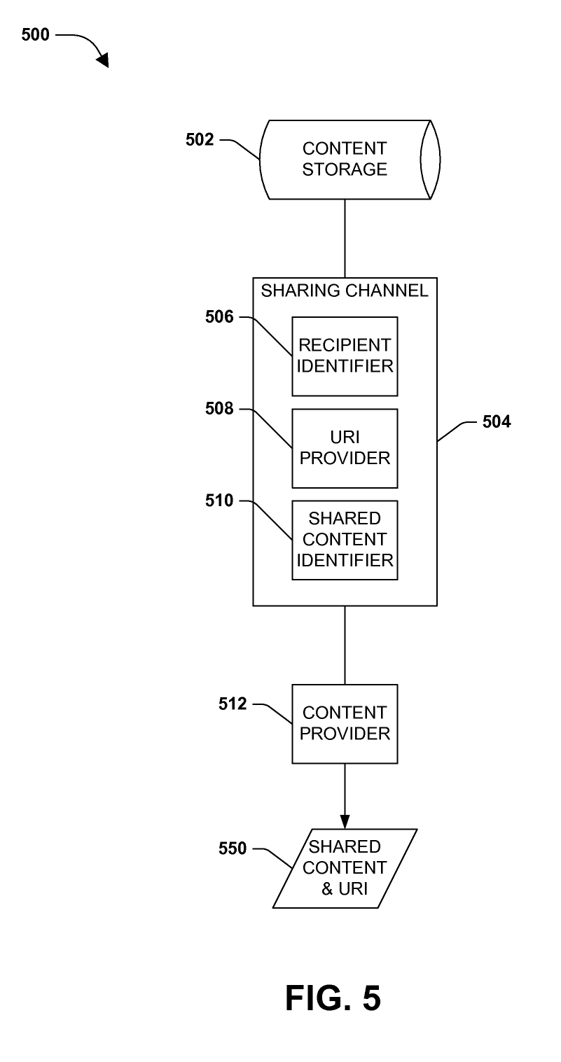

FIG. 5 is a component diagram of an exemplary system 500 for sharing user content. A content storage component 502 provides access to user selected content stored thereon. A sharing channel component 504 is operably coupled with the content storage component 502. The sharing channel component 504 is configured to share the user selected content, resident on the content storage component 502, with one or more recipients. It will be appreciated that the content storage component 502 is not limited to any particular location, and may comprise a single location, such as a local client device or remote server, and/or may comprise a plurality of locations (e.g., several servers and/or devices). For example, the sharing channel may utilize one or more content servers for content storage 502 (e.g., which may or may not be remote from each other), and may also utilize local device storage. In this example, the sharing channel may be operably coupled with respective storage locations, and/or may be operably coupled with one or more locations that provide access to other locations.

The sharing channel component 504 comprises a recipient identification component 506 that identifies at least one endpoint for respective one or more recipients of the user selected content. Further, the sharing channel component 504 comprises a universal resource identification component 508 that provides a universal resource identifier (URI) link to a location of the stored user selected content, such as on the content storage component 502. Additionally, the sharing channel component 504 comprises a shared content identification component 510 that identifies the selected user content, such as on the content storage component 502.

A content providing component 512 is operably coupled with the sharing channel component 504. Upon activation of the sharing channel component 504 by a user, the content providing component 512 automatically provides at least one of the identified, selected content and URI link 550 to the respective endpoints that are identified by the recipient identification component 506. For example, the user can select content to share using the sharing channel from the content storage component. Upon selection of the content, the shared content is identified, along with the URI, and the content providing component 512 sends at least one of the selected content and URI 550 to the one or more endpoints of the one or more recipients identified by/for the sharing channel.

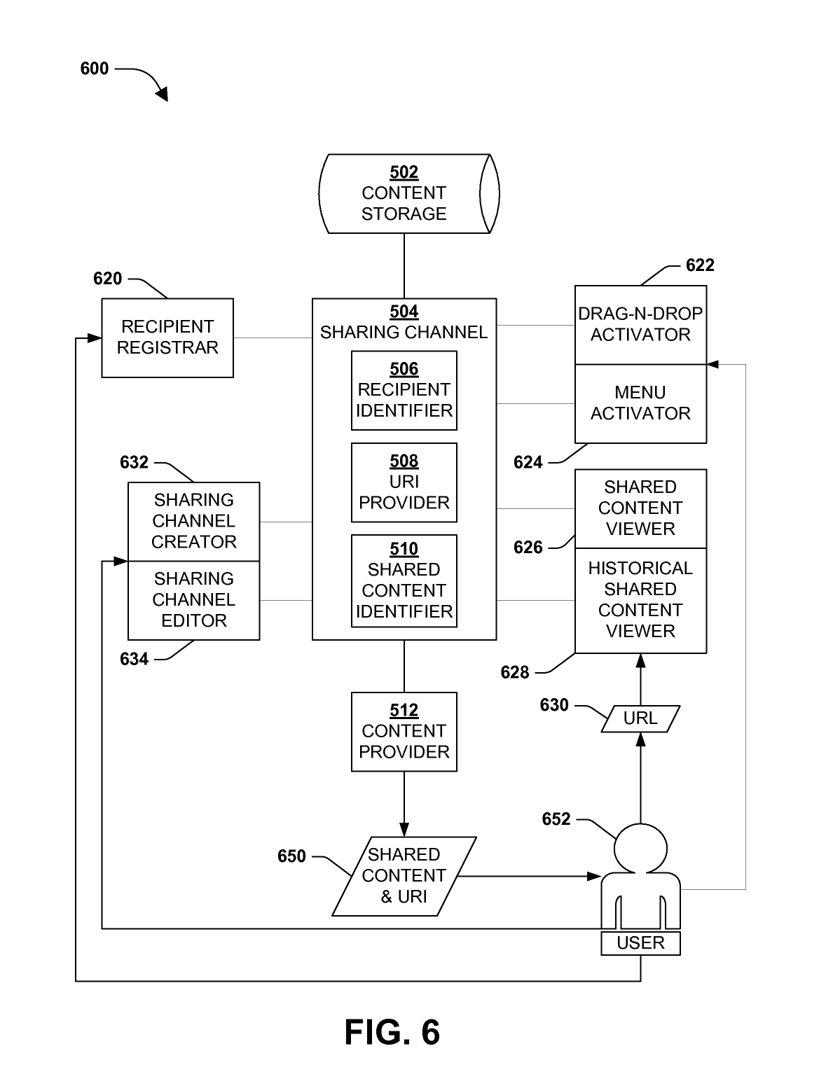

FIG. 6 is a component diagram illustrating one embodiment 600 where one or more systems described herein may be implemented. In this example, an extension of FIG. 5 is provided and thus description of elements, components, etc. described with respect to FIG. 5 may not be repeated for simplicity. A sharing channel creation component 632 can create a sharing channel (e.g., 504) upon activation by a user 652. For example, the user may activate the sharing channel creation component 632 by selecting content to share with a new sharing channel (e.g., by dragging content to a new sharing channel activation UI element). As another example, the user may activate the new sharing channel creation component 632 by using a file menu activation component (e.g., selecting a file menu UI element).

A recipient registration component 620 can register one or more respective endpoints for at least one of the one or more recipients in the sharing channel 504. For example, a user 652 may utilize the recipient register to register one or more endpoints (e.g., locations that can receive shared content) for respective recipients identified by the recipient identification component 506. As an example, the user 652 may utilize a contacts list of recipients to populate the sharing channel with one or more recipients and/or one or more endpoints for a recipient.

In one embodiment, the endpoint can comprise an email address; a phone number (e.g., a mobile phone number to receive a text message); a text short code; an instant message address; a storage address (e.g., a URI that identifies a storage server); an Internet Protocol (IP) address (e.g., leading to a port for receiving content); and/or a locator address where a recipient can receive content, etc. In one embodiment, a recipient in the sharing channel 504 can comprise one or more endpoints. Further, shared content can be sent to more than one endpoint for a recipient (e.g., so that a recipient receives a digital image via both email and text message).

A drag-and-drop activation component 622 can activate the content providing component 512 upon receiving an indication of dragging and dropping the user selected content into the sharing channel 504 in a user interface (UI) of a device used by the user 652. Further, a menu activation component 624 can activate the content providing component 512 upon receiving an indication of a selection of a sharing channel menu item from a file menu associated with the user selected content. That is, for example, the user 652 may activate the content providing component 512 to send shared content and the URI 650 from the shared channel by dragging content to the sharing channel 504, and/or selecting a menu UI item.

A shared content viewing component 626 can provide access to the user selected content in the sharing channel 504 upon activation of the URI link by a recipient. In one embodiment, the URI can comprise a persistent universal resource locator (URL) 630 used to access the selected content in an online document. For example, the recipient can activate the URL (e.g., use the URL in a browser) to locate a website comprising the sharing channel, which can provide a view of (and/or other interaction with) the shared content.

Further, an historical shared content viewing component 628 can provide access to at least some previously selected content for the sharing channel. In this way, for example, a recipient may be able to navigate to a site comprising the sharing channel 504 to view content selected by the user 652 for sharing. The recipient may be able to view historic content, for example, comment on content, edit content, download content, etc., based on authorizations/permissions assigned to the recipient for the sharing channel.

A sharing channel editing component 634 can allow the user 652 to edit the one or more recipients registered for the sharing channel 504, such as to add or remove a recipient for the sharing channel 504. Further, the sharing channel editing component 634 can allow the user 652 to edit one or more endpoints for the one or more recipients registered for the sharing channel 504, such as to add, remove, edit, update, etc. an endpoint for a recipient. The sharing channel editing component 634 can also allow the user 652 to edit the URI link for the shared content in the sharing channel 504 (e.g., to obtain the contend from a different location). Additionally, the sharing channel editing component 634 can allow the user 652 to edit the shared content associated with the sharing channel, such as to remove or edit the shared content (e.g., add a new digital image to an album).

In another embodiment, the user 652 may share selected content from a sharing channel by sending the sharing channel to a desired recipient. For example, the sharing channel, comprising content selected by the user for sharing, can sent by email, instant message, or some other means, to a desired endpoint that is not comprised in the sharing channel as associated with a recipient. As an illustrative example, the user 652 may email the persistent URL 630 associated with the sharing channel 504 to a desired endpoint. In this example, the endpoint recipient can browse to the sharing channel 504 using the URL 630.

In one embodiment, the sharing channel 504 can be portable, for example, where it may be incorporated to a local operating system for sharing local content, and/or incorporated to an online service for sharing remotely stored content. For example, the user may acquire video using a video capture device, download the video to their local machine, and drag-n-drop the video to the sharing channel disposed on their local desktop. Further, as an example, the user can later navigate to an online service comprising stored documents and drag-n-drop a document, for example, into the sharing channel disposed in their browser, where the sharing channel was moved (e.g., via drag-n-drop) from their local desktop to their browser and/or an instance of the sharing channel was provided, created, etc. in their browser, for example. That is, while the sharing channel can be defined locally, one or more instances of the sharing channel can be instantiated in other platforms as well, such as for cloud-based services and/or online sites, etc. (e.g., websites, remote servers, etc.).

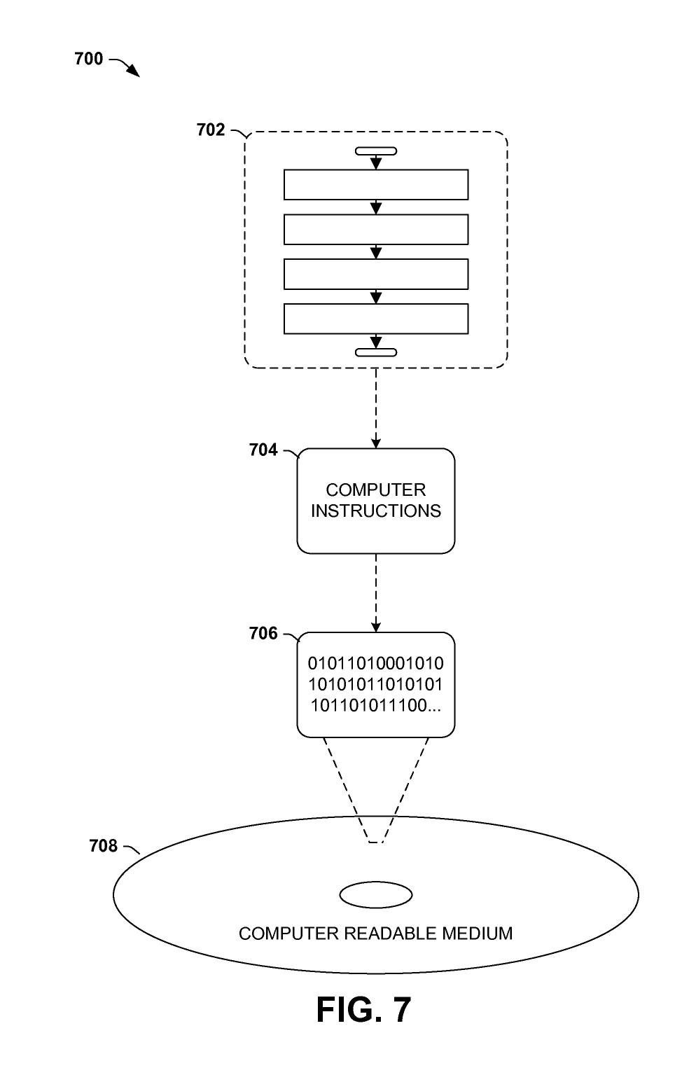

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

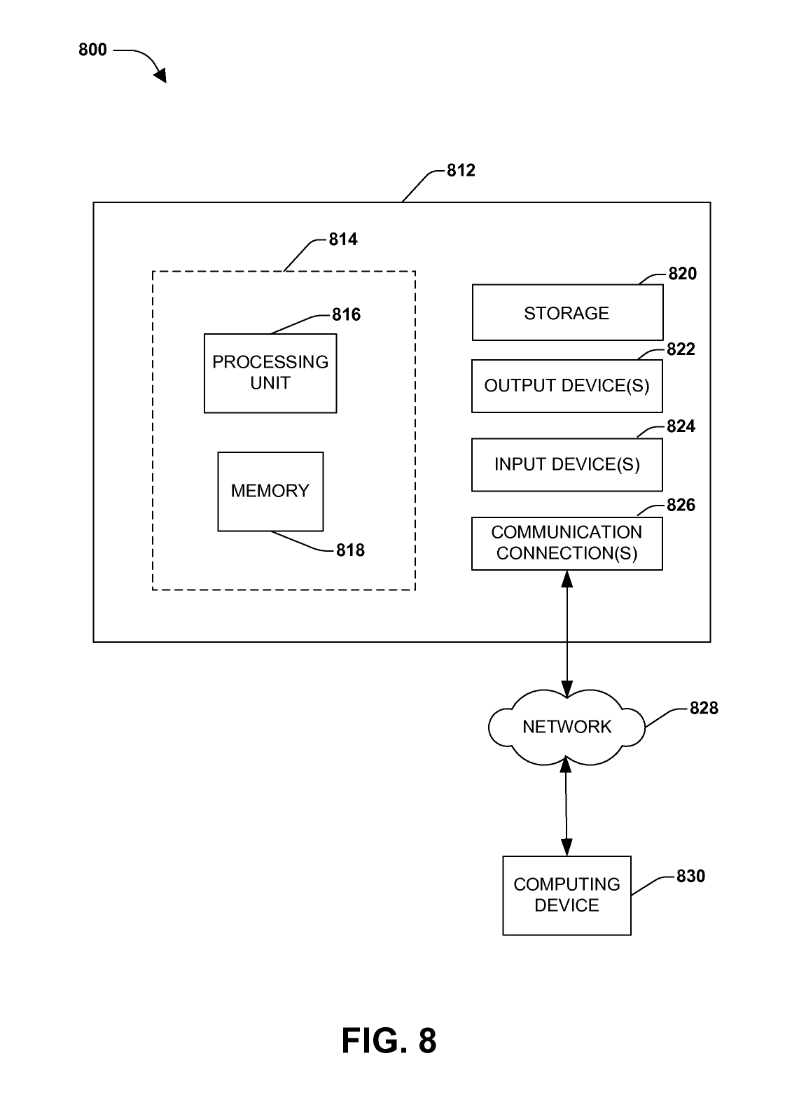

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for sharing content, comprising:
associating at least one endpoint with a recipient in a sharing channel used to share user selected content with one or more recipients comprised in the sharing channel; and
upon receiving a user selection of content to share using the sharing channel, automatically sending at least one of the selected content and a universal resource identifier (URI), comprising a link to a storage location of the selected content, to the one or more endpoints for the respective one or more recipients comprised in the sharing channel, using a computer-based processor.

2. The method of claim 1, comprising storing the selected content in the storage location such that the content is accessible over a network using the URI.

3. The method of claim 2, comprising identifying a universal resource locator (URL), comprising the URI, for the storage location of the selected content in a cloud-based storage.

4. The system of claim 1, receiving a user selection of content to share using the sharing channel comprising at least one of:
receiving input indicative of dragging and dropping a user interface (UI) representation of the selected content to a UI representation of the sharing channel; and
receiving input indicative of selecting a file menu item associated with the selected content that is indicative of using the sharing channel to share the selected content.

5. The method of claim 1, comprising obtaining the selected content for the sharing channel using an online service that provides cloud-based storage of the selected content.

6. The method of claim 1, comprising at least one of:
creating a second instance of the sharing channel at a location other than a location of the sharing channel, and
creating the sharing channel comprising the one or more recipients respectively comprising one or more endpoints.

7. The method of claim 6, creating the sharing channel comprising one or more of:
identifying one or more recipients for the selected content;
identifying one or more endpoints for the respective one or more recipients, respective endpoints comprising a location for receiving the selected content; and
identifying one or more authorizations for the selected content for the respective one or more recipients.

8. The method of claim 1, comprising providing access to the selected content for the sharing channel upon activation of the URI by a recipient.

9. The method of claim 8, providing access to the selected content for the sharing channel comprising providing a historical view of at least some previously selected content for the sharing channel.

10. A system for sharing user content, comprising:
a content storage component configured to provide access to user selected content stored thereon;
a sharing channel component operably coupled with the content storage component and configured to share the user selected content with one or more recipients, comprising:
a recipient identification component configured to identify at least one endpoint for respective one or more recipients of the user selected content;
a universal resource identification component configured to provide a universal resource identifier (URI) link to a location of the stored user selected content; and
a shared content identification component configured to identify the selected user content; and
a content providing component operably coupled with the sharing channel component and configured to automatically provide at least one of the identified, selected content and the URI link to the respective endpoints identified by the recipient identification component, upon activation of the sharing channel by a user.

11. The system of claim 10, comprising a recipient registration component configured to register respective endpoints for at least one of the one or more recipients in the sharing channel.

12. The system of claim 10, comprising a drag-and-drop activation component configured to activate the content providing component upon receiving an indication of dragging and dropping the user selected content into the sharing channel in a user interface (UI) of a device used by the user.

13. The system of claim 10, comprising a menu activation component configured to activate the content providing component upon receiving an indication of a selection of a sharing channel menu item from a file menu associated with the user selected content.

14. The system of claim 10, comprising a shared content viewing component configured to provide access to the user selected content in the sharing channel upon activation of the URI link by a recipient.

15. The system of claim 14, the URI comprising a persistent universal resource locator (URL) used to access the selected content in an online document.

16. The system of claim 14, comprising an historical shared content viewing component configured to provide access to at least some previously selected content for the sharing channel.

17. The system of claim 10, comprising a sharing channel creation component configured to create a new sharing channel upon receipt of an indication of activation by the user.

18. The system of claim 10, comprising a sharing channel editing component configured to one or more of:
edit the one or more recipients registered for the sharing channel;
edit one or more endpoints for the one or more recipients registered for the sharing channel;
edit the URI link for the shared content in the sharing channel; and
edit the shared content associated with the sharing channel.

19. The system of claim 10, the endpoint comprising one or more of:
an email address;
a phone number;
a text short code;
an instant message address;
a storage address;
an Internet Protocol (IP) address; and
a locator address where a recipient receives content.

20. A computer readable medium comprising computer executable instructions that when executed via a processor on a computer perform a method, for sharing user content, comprising:
storing user selected content in a storage location such that the content is accessible over a network using a universal resource identifier (URI);
creating a sharing channel comprising one or more recipients, respectively comprising one or more endpoints, comprising associating at least one endpoint with the respective one or more recipients in the sharing channel, the sharing channel used to share user selected content with the one or more recipients;
upon receiving a user selection of content to share using the sharing channel, automatically sending at least one of the selected content and a universal resource identifier (URI), comprising a link to the storage location of the selected content, to the respective the one or more recipients comprised in the sharing channel.
